(19) United States
(12) Patent Application Publication
(10) Pub. No.: US 2021/0333182 A1
(43) Pub. Date: Oct. 28, 2021

(54) MATERIAL TESTING MACHINE AND DISPLAY METHOD IN MATERIAL TESTING MACHINE

(71) Applicant: SHIMADZU CORPORATION, Kyoto (JP)

(72) Inventors: Takuro SATO, Kyoto (JP); Tomotaka NAGASHIMA, Kyoto (JP); Yukimitsu IWANAGA, Kyoto (JP)

(73) Assignee: SHIMADZU CORPORATION, Kyoto (JP)

(21) Appl. No.: 17/235,945

(22) Filed: Apr. 21, 2021

(30) Foreign Application Priority Data
Apr. 24, 2020 (JP) 2020-077345

(51) Int. Cl. G01N 3/06; G01N 3/08

(52) U.S. Cl. CPC G01N 3/068; G01N 3/08

(57) ABSTRACT

Provided is a material testing machine that deforms a test piece and measures mechanical properties of a material of the test piece. The material testing machine includes: a first detection unit that detects a strain of the test piece by measuring a distance between reference points of the test piece; a second detection unit that detects a strain distribution of the test piece based on an image of a pattern formed on a surface of the test piece; and a display control unit that displays a detection result of the first detection unit and a detection result of the second detection unit on one screen.

### INCORPORATION BY REFERENCE

The present application claims priority under 35 U.S.C. § 119 to Japanese Patent Application No. 2020-077345 filed on Apr. 24, 2020. The content of the application is incorporated herein by reference in its entirety.

### BACKGROUND

### Technical Field

The present invention relates to a material testing machine and a display method in the material testing machine.

### Related Art

Various techniques for detecting a strain of a test piece are known in a material testing machine that deforms the test piece, and measures mechanical properties of a material of the test piece.

For example, JP 2012-58013 A discloses a material testing machine that generates an image by imaging a pair of reference line marks attached to a surface of a test piece with a video camera and measures elongation of the test piece by using a position of the image of the pair of reference line marks.

For example, JP 2019-52997 A discloses a material testing machine that displays elongation of a test piece and testing force.

However, in the material testing machines disclosed in JP 2012-58013 A and JP 2019-52997 A, the relationship between the elongation of the test piece and the testing force is only visualized, and there is a case in which information desired by a user cannot be provided. For example, in a tensile test that detects the elongation and the testing force of the related art, it is known that a complicated strain of the test piece is formed in a test section before a yield point, but there has not been a material testing machine that can analyze such a complicated strain state.

The present invention has been made in view of such circumstances, and an object of the present invention is to provide a material testing machine capable of providing information desired by a user, and a display method in the material testing machine.

### SUMMARY

According to a first aspect of the present invention, there is provided a material testing machine that deforms a test piece and measures mechanical properties of a material of the test piece. The material testing machine includes: a first detection unit that detects at least one of elongation and a strain of the test piece by measuring a distance between reference points of the test piece; a second detection unit that detects a strain distribution of the test piece based on an image of a pattern formed on a surface of the test piece; and a display unit that displays a detection result of the first detection unit and a detection result of the second detection unit in association with each other.

According to a second aspect of the present invention, there is provided a display method in a material testing machine that deforms a test piece and measures mechanical properties of a material of the test piece. The method includes: a first detection step of detecting at least one of elongation and a strain of the test piece by measuring a distance between reference points of the test piece; a second detection step of detecting a strain distribution of the test piece based on an image of a pattern formed on a surface of the test piece; and a display step of displaying a detection result in the first detection step and a detection result in the second detection step in association with each other.

### BRIEF DESCRIPTION OF DRAWINGS

FIG. 1 is a diagram illustrating an example of a configuration of a tensile testing machine according to the present embodiment;

FIG. 2 is a plan view illustrating an example of a configuration of a material testing machine;

FIG. 3 is a diagram illustrating an example of a configuration of a main part of a tensile testing machine;

FIG. 4 is a diagram illustrating an example of a pattern image;

FIG. 5 is a diagram illustrating an example of a method of calculating a vertical strain distribution of a test piece;

FIG. 6 is a screen view illustrating an example of a test result display screen displayed on a display unit;

FIG. 7 is a diagram illustrating a first example of a strain and a strain distribution image;

FIG. 8 is a diagram illustrating a second example of a strain and a strain distribution image;

FIG. 9 is a diagram illustrating a third example of a strain and a strain distribution image;

FIG. 10 is a diagram illustrating a fourth example of a strain and a strain distribution image;

FIG. 11 is a diagram illustrating a fifth example of a strain and a strain distribution image;

FIG. 12 is a flowchart illustrating an example of processing of a control unit during a test;

FIG. 13 is a flowchart illustrating an example of processing of a control unit after a test; and

FIG. 14 is a flowchart illustrating an example of processing of a control unit after a test.

### DETAILED DESCRIPTION

According to the first aspect of the present invention, the material testing machine includes the first detection unit that detects at least one of the elongation and the strain of the test piece, the second detection unit that detects the strain distribution of the test piece, and the display unit that displays the detection result of the first detection unit and the detection result of the second detection unit in association with each other.

Therefore, the detection result of at least one of the elongation and the strain, and the detection result of the strain distribution are displayed in association with each other, and thus information desired by a user can be provided.

According to a second aspect of the present invention, the display method in a material testing machine includes the first detection step of detecting at least one of the elongation and the strain of the test piece, the second detection step of detecting the strain distribution of the test piece, and the display step of displaying the detection result in the first detection step and the detection result in the second detection step in association with each other.

Therefore, the detection result of at least one of the elongation and the strain, and the detection result of the strain distribution are displayed in association with each other, and thus information desired by a user can be provided.

Hereinafter, the present embodiment will be described with reference to the drawings.

1. Configuration of Tensile Testing Machine

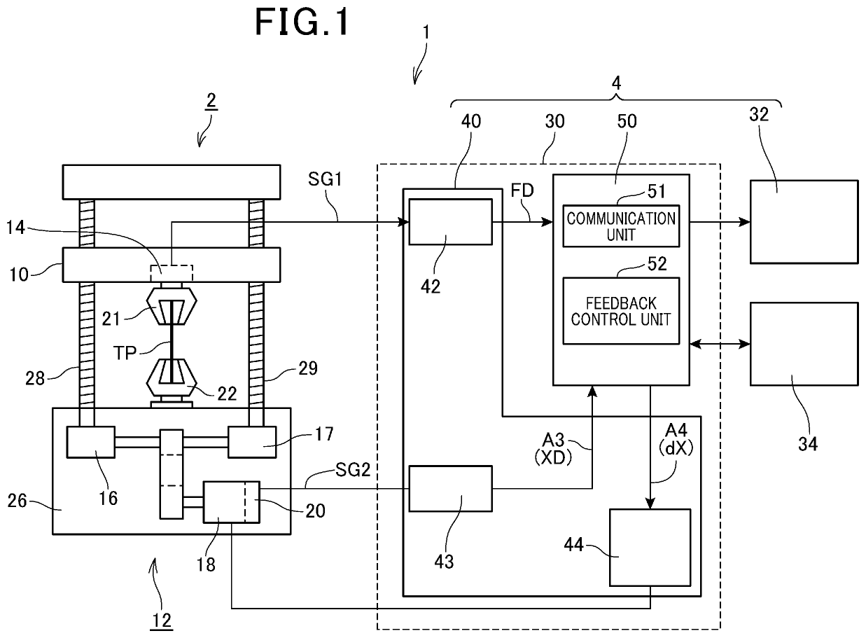

FIG. 1 is a diagram illustrating an example of a configuration of a tensile testing machine 1 according to the present embodiment.

The tensile testing machine 1 of the present embodiment applies testing force F to a test piece TP to perform a material test for measuring mechanical properties such as a tensile strength, a yield point, elongation, and a reduction area of a sample. The testing force F is a tensile force.

The tensile testing machine 1 includes a testing machine main body 2 that applies the testing force F to the test piece TP, which is a material to be tested, to perform a tensile test, and a control unit 4 that controls a tensile test operation performed by the testing machine main body 2.

The tensile testing machine 1 corresponds to an example of a “material testing machine”.

The testing machine main body 2 includes a table 26, a pair of screw rods 28 and 29 rotatably erected on the table 26 in a vertical direction, a crosshead 10 that can move along the screw rods 28 and 29, a load mechanism 12 that applies a load to the test piece TP by moving the crosshead 10, and a load cell 14. The load cell 14 is a sensor that measures the testing force F, which is a tensile load applied to the test piece TP, and outputs a testing force measurement signal SG1.

The load mechanism 12 includes worm reducers 16 and 17 respectively connected to a lower end of each of the screw rods 28 and 29, a servo motor 18 connected to each of the worm reducers 16 and 17, and a rotary encoder 20. The rotary encoder 20 is a sensor that measures a rotation amount of the servo motor 18 and outputs a rotation measurement signal SG2 having a pulse number corresponding to the rotation amount of the servo motor 18 to the control unit 4.

The load mechanism 12 transmits the rotation of the servo motor 18 to the pair of screw rods 28 and 29 via the worm reducers 16 and 17, and the crosshead 10 moves up and down along the screw rods 28 and 29 by rotating the screw rods 28 and 29 in synchronization with each other.

The crosshead 10 is provided with an upper gripper 21 that grips an upper end of the test piece TP, and the table 26 is provided with a lower gripper 22 that grips a lower end of the test piece TP. At the time of the tensile test, the testing machine main body 2 applies the testing force F to the test piece TP by lifting the crosshead 10 according to the control of the control unit 4 in a state in which both ends of the test piece TP are gripped by the upper gripper 21 and the lower gripper 22.

The control unit 4 includes a general control device 30, a display device 32 (display), and a test program execution device 34.

The general control device 30 is a device that mainly controls the testing machine main body 2, and is connected to the testing machine main body 2 so as to be capable of transmitting and receiving signals. The signals received from the testing machine main body 2 are the testing force measurement signal SG1 output by the load cell 14, the rotation measurement signal SG2 output by the rotary encoder 20, and appropriate signals required for control and testing.

The display device 32 is a device that displays various information based on a signal input from the general control device 30, for example, the general control device 30 causes the display device 32 to display a displacement measurement value XD indicating a displacement of the crosshead 10 based on the rotation measurement signal SG2 during the tensile test.

The tensile test program execution device 34 is a device including a function of receiving a user operation such as a setting operation of various setting parameters such as a test condition of the tensile test and an execution instruction operation to output them to the general control device 30, and a function of analyzing data of a testing force measurement value FD.

The tensile test program execution device 34 includes a computer, the computer including a processor such as a central processing unit (CPU) and a micro-processing unit (MPU), a memory device such as a read only memory (ROM) and a random access memory (RAM), a storage device (memory) such as a hard disk drive (HDD) and a solid state drive (SSD), and an interface circuit for connecting the general control device 30 and various peripheral devices. The processor implements the various functions by executing the tensile test program, which is a computer program stored in the memory device or the storage device.

Next, the general control device 30 of the present embodiment will be further described. The general control device 30 includes a signal input and output unit 40 and a control circuit unit 50.

The signal input and output unit 40 configures an input and output interface circuit that transmits and receives a signal to and from the testing machine main body 2. In the present embodiment, the signal input and output unit 40 includes a sensor amplifier 42, a counter circuit 43, and a servo amplifier 44.

The sensor amplifier 42 is an amplifier that amplifies the testing force measurement signal SG1 output by the load cell 14 and outputs the amplified testing force measurement signal SG1 to the control circuit unit 50.

The counter circuit 43 counts the pulse number of the rotation measurement signal SG2 output by the rotary encoder 20, and outputs the rotation amount of the servo motor 18, that is, a displacement measurement signal A3 indicating the displacement measurement value XD of the crosshead 10 moving up and down according to the rotation of the servo motor 18 to the control circuit unit 50 as a digital signal. The servo amplifier 44 is a device that controls the servo motor 18 according to the control of the control circuit unit 50.

The control circuit unit 50 includes a communication unit 51 (transmitter/receiver, circuit) and a feedback control unit 52.

The control circuit unit 50 includes a computer including a processor such as a CPU and an MPU, a memory device such as a ROM and a RAM, a storage device such as an HDD and an SSD, an interface circuit with the signal input and output unit 40, a communication device communicating with the tensile test program execution device 34, a display control circuit controlling the display device 32, and various electronic circuits. Each functional unit illustrated in FIG. 1 is implemented by the processor of the control circuit unit 50 executing the control program stored in the memory device or the storage device.

An A/D converter is provided in the interface circuit of the signal input and output unit 40, and the testing force measurement signal SG1 and an elongation measurement signal SG3, which are analog signals, are converted into digital signals by the A/D converter.

The control circuit unit 50 is not limited to the computer, and may be configured of one or more appropriate circuits including an integrated circuit such as an IC chip or an LSI.

The communication unit 51 communicates with the test program execution device 34, and receives, from the test program execution device 34, a test condition setting or set values of various setting parameters, and an execution instruction or an interruption instruction of the tensile test. The communication unit 51 transmits the testing force measurement value FD based on the testing force measurement signal SG1 to the test program execution device 34 at an appropriate timing. The communication unit 51 transmits the displacement measurement value XD based on the rotation measurement signal SG2 to the test program execution device 34 at an appropriate timing.

The feedback control unit 52 feedback-controls the servo motor 18 of the testing machine main body 2 to execute the tensile test. The feedback control unit 52 is a circuit that executes the feedback control of the servo motor 18.

When the feedback control unit 52 executes a position control, the feedback control unit 52 executes the position control for, for example, the testing force measurement value FD output by the load cell 14. In this case, the feedback control unit 52 calculates a command value dX of the displacement measurement value XD so that the testing force measurement value FD matches a testing force target value FT, and outputs a command signal A4 indicating the command value dX to the servo amplifier 44. The testing force target value FT indicates a target value of the testing force measurement value FD.

2. Configuration of Detection Device

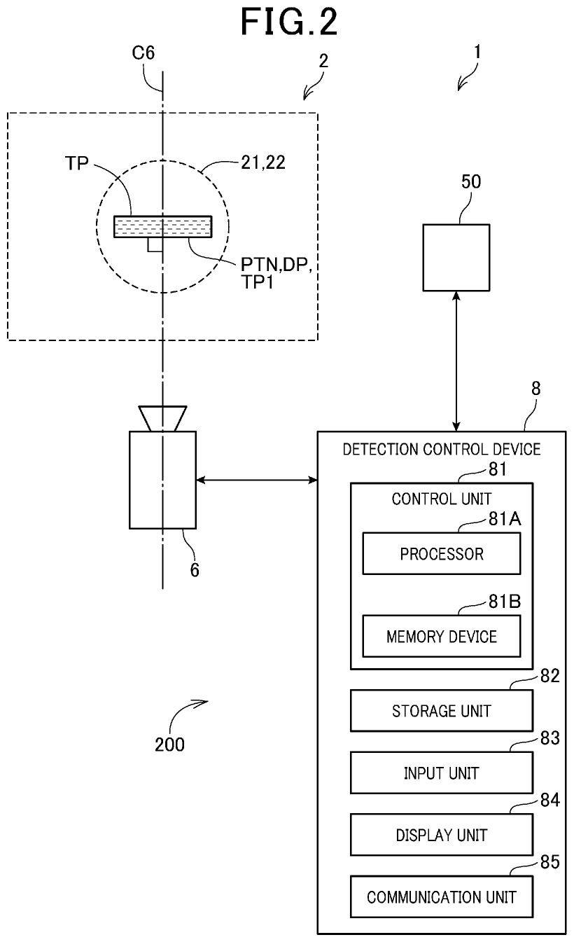

FIG. 2 is a plan view illustrating an example of a configuration of a detection device 200. The tensile testing machine 1 further includes a detection device 200. As illustrated in FIG. 2, the detection device 200 is a device that detects a strain ε and a strain distribution DT of the test piece TP, the detection device including a camera 6 and a detection control device 8.

A pair of reference points DP and a pattern PTN are formed on a specific surface TP1 of the test piece TP. The specific surface TP1 indicates a surface of the test piece TP on a side close to the camera 6. The side of the test piece TP close to the camera 6 indicates the lower side in FIG. 2.

The reference point DP includes a first reference point DPI and a second reference point DP2. The first reference point DP1 is disposed on an upper portion of the specific surface TP1, and the second reference point DP2 is disposed on a lower portion of the specific surface TP1.

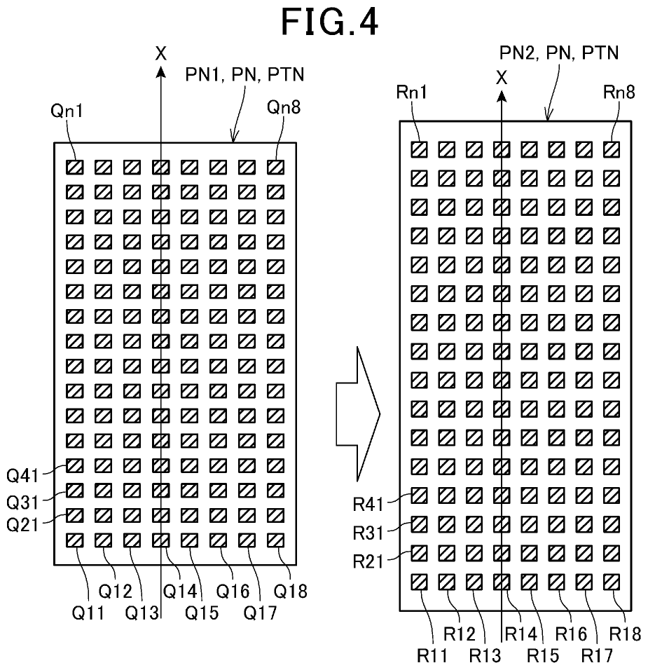

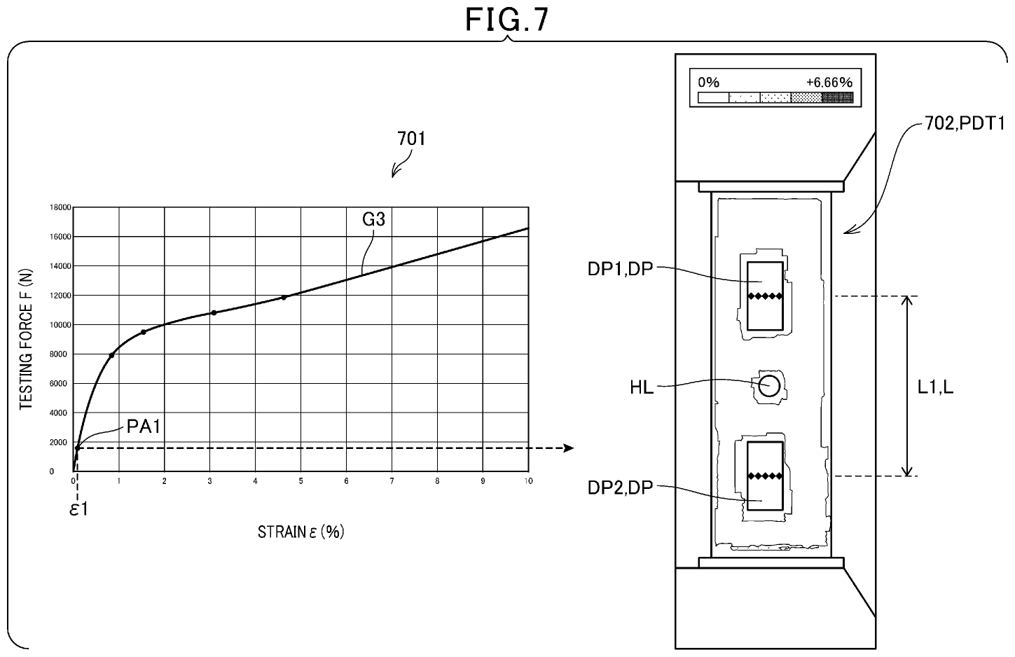

The reference point DP will be described later with reference to FIG. 7. The pattern PTN will be described later with reference to FIG. 4.

The camera 6 generates an image including a pattern image PN showing the image of the pattern PTN and an image of the reference point DP according to the instruction of the detection control device 8.

The camera 6 includes an image sensor such as a charge coupled device (CCD) and a complementary MOS (CMOS). The pattern image PN will be described later with reference to FIG. 4.

The camera 6 is disposed so that the imaging direction C6 of the camera 6 is orthogonal to the specific surface TP1 of the test piece TP through a center of the test piece TP in a width direction. The width direction of the test piece TP indicates a right and left direction in FIG. 2. The imaging direction C6 indicates a center of the imaging range of the camera 6.

The camera 6 generates a pattern image PN showing an image of the pattern PTN and an image of the reference point DP at every predetermined time ΔT while the tensile testing machine 1 is performing the tensile test of the test piece TP. The predetermined time ΔT is, for example, 1/30 seconds. In other words, a frame rate of the camera 6 is 30 fps.

In the present embodiment, the frame rate of the camera 6 is 30 fps, but the embodiment of the present invention is not limited to this. The frame rate of the camera 6 may be determined depending on a deformation rate of the test piece TP and a lattice interval formed on the test piece TP. For example, it is preferable to increase the frame rate as the deformation rate of the test piece TP increases. For example, it is preferable to increase the frame rate as the lattice interval formed on the test piece TP is narrower.

As illustrated in FIG. 2, the detection control device 8 is a personal computer including a control unit 81, a storage unit 82 (memory), an input unit 83, a display unit 84 (display), a communication unit 85 (transmitter/receiver, circuit), and various electronic circuits.

The control unit 81 controls an operation of the detection device 200. The control unit 81 is configured to be capable of communicating with the control circuit unit 50, and controls an operation of the camera 6 according to the instruction from the control circuit unit 50. For example, the control unit 81 determines an imaging timing of the camera 6 according to the instruction from the control circuit unit 50.

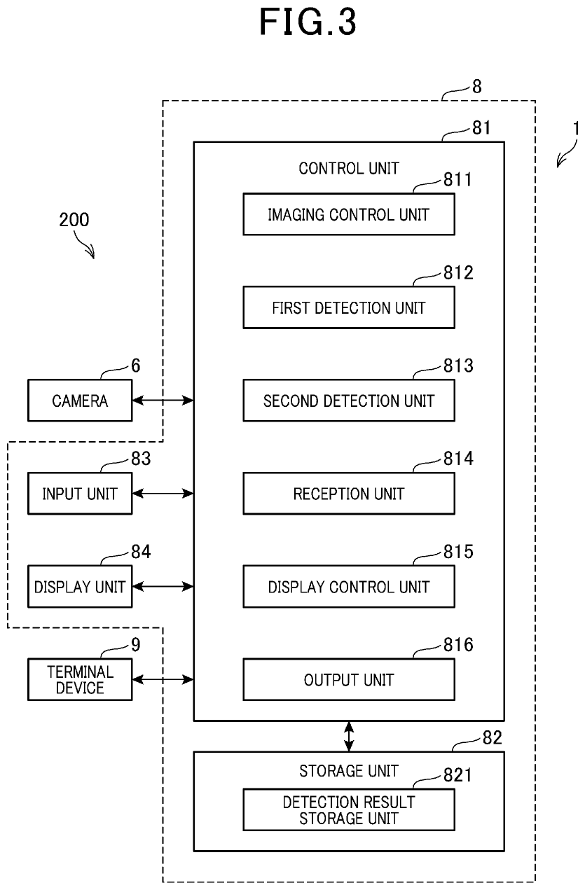

The control unit 81 includes a processor 81A such as a CPU and an MPU, and a memory device 81B such as a ROM and a RAM. Each functional unit illustrated in FIG. 3 is implemented by the processor 81A executing the control program stored in the memory device 81B.

The storage unit 82 includes an HDD and an SSD. The storage unit 82 stores various information.

The input unit 83 receives an operation input from the user. The input unit 83 includes, for example, a mouse and a keyboard.

The display unit 84 includes a liquid crystal display (LCD), and displays various images.

The communication unit 85 communicates with the control circuit unit 50 and the camera 6. The communication unit 85 receives various information from the control circuit unit 50. The communication unit 85 receives image information generated by the camera 6.

The detection control device 8 is not limited to the personal computer, and may be configured of one or more appropriate circuits including an integrated circuit such as an IC chip or an LSI. The detection control device 8 may be configured as, for example, a tablet terminal or a smartphone.

The detection control device 8 may include programmed hardware such as a digital signal processor (DSP) and a field programmable gate array (FPGA). The detection control device 8 may include a system-on-a-chip (SoC)-FPGA.

3. Configuration of Control Unit

FIG. 3 is a diagram illustrating an example of a configuration a main part of the tensile testing machine 1 according to the present embodiment.

As illustrated in FIG. 3, the control unit 81 includes an imaging control unit 811, a first detection unit 812, a second detection unit 813, a reception unit 814, a display control unit 815, and an output unit 816.

Specifically, the processor 81A of the control unit 81 executes a control program stored in the memory device 81B to function as the imaging control unit 811, the first detection unit 812, the second detection unit 813, the reception unit 814, the display control unit 815, and the output unit 816.

The processor 81A of the control unit 81 executes the control program stored in the memory device 81B to cause the storage unit 82 to function as a detection result storage unit 821.

The detection result storage unit 821 stores a detection result of the strain ε and a detection result of the strain distribution DT. The detection result storage unit 821 stores, for example, the detection result of the strain ε and the detection result of the strain distribution DT in association with a time T within a test period of the tensile test. The detection result of the strain distribution DT includes a strain distribution image PDT. The strain distribution image PDT is an image showing the strain distribution DT.

The strain distribution image PDT will be described later with reference to FIG. 7.

The time T corresponds to an example of an “elapsed time from start of the test”.

The detection result storage unit 821 corresponds to an example of the “storage unit”.

The imaging control unit 811 causes the camera 6 to capture an image including the pattern PTN and the image of the reference point DP, which are formed on the test piece TP, and generates a pattern image PN showing the image of the pattern PTN and an image of the reference point DP. For example, the imaging control unit 811 generates the pattern image PN and the image of the reference point DP according to an instruction from the control circuit unit 50.

The imaging control unit 811 generates the pattern image PN and the image of the reference point DP at every predetermined time ΔT. The predetermined time ΔT is, for example, 1/30 seconds. Specifically, until the execution of the tensile test is ended after the tensile testing machine 1 starts to execute the tensile test, the imaging control unit 811 generates the pattern image PN and the image of the reference point DP at every predetermined time ΔT.

The first detection unit 812 detects a strain ε of the test piece TP based on the image of the reference point DP. For example, the first detection unit 812 detects the strain ε of the test piece TP as follows. First, the first detection unit 812 detects, for example, a distance L between the reference points of the test piece TP based on the image of the reference point DP. The distance L between the reference points is a distance between the first reference point DP1 and the second reference point DP2. Then, the first detection unit 812 detects a strain ε (%) of the test piece TP by Equation (1).

ε=(LN−L0)/L0×100 (1)

A distance L0 between the reference points indicates the distance L between the reference points before the tensile test is started. A distance LN between the reference points indicates the distance L between the reference points during the tensile test. The distance LN between the reference points includes a distance L1 between the reference points to a distance L5 between the reference points, which are illustrated FIGS. 7 to 11.

In the present embodiment, a case in which the first detection unit 812 detects the strain ε is described, but the first detection unit 812 may detect elongation (=LN−L0). The first detection unit 812 may detect the elongation and the strain ε.

In the present embodiment, a case in which the first detection unit 812 detects the distance L between the reference points based on the image of the reference point DP generated by the camera 6 is described, but the first detection unit 812 may detect the distance L between the reference points based on a detection signal from a gripping-type extensometer.

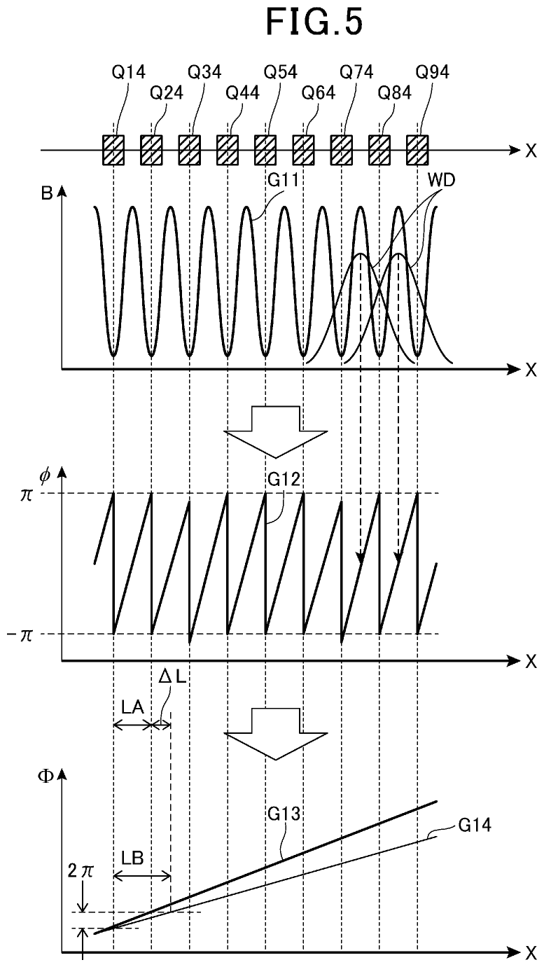

The second detection unit 813 detects the strain distribution DT of the test piece TP based on the image of the pattern PTN formed on the surface of the test piece TP. A method of calculating the strain distribution DT will be described later with reference to FIGS. 4 and 5.

The reception unit 814 receives an instruction from the user via the input unit 83.

The reception unit 814 receives, for example, a designation of a time T within a test period for the test piece TP. The reception unit 814 receives, for example, a designation of the strain ε of the test piece TP. The reception unit 814 receives, for example, a designation of the testing force F to be applied to the test piece.

The reception unit 814 receives, for example, one strain distribution DT among a vertical strain distribution DT1, a lateral strain distribution DT2, and a shear strain distribution DT3. The vertical strain distribution DT1 indicates a strain distribution in the vertical direction. The lateral strain distribution DT2 indicates a strain distribution in the lateral direction. The shear strain distribution DT3 indicates a distribution of a shear strain.

The reception unit 814 corresponds to an example of a “first reception unit”, a “second reception unit”, a “third reception unit”, and a “fourth reception unit”.

The display control unit 815 displays various images on the display unit 84. The display control unit 815 displays, for example, the detection result of the first detection unit 812 and the detection result of the second detection unit 813 on one screen. The display control unit 815 displays, for example, a test result display screen 700 on the display unit 84.

The display control unit 815 corresponds to a part of the “display unit”. That is, the display control unit 815 and the display unit 84 form a “display unit”.

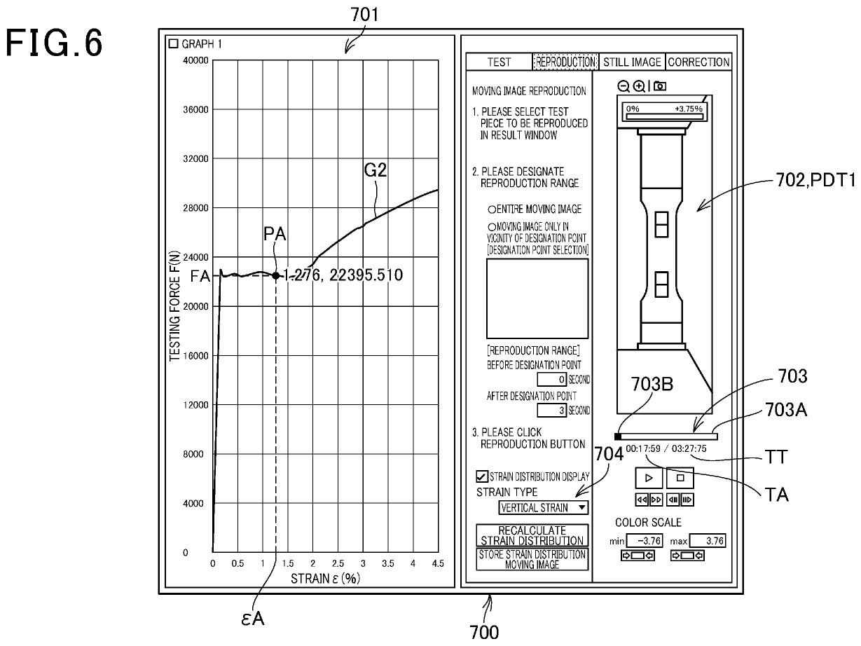

The test result display screen 700 will be described later with reference to FIG. 6.

In the present embodiment, the display control unit 815 displays the detection result of the first detection unit 812 and the detection result of the second detection unit 813 on one screen. The display control unit 815 may display the detection result of the first detection unit 812 and the detection result of the second detection unit 813 in association with each other. For example, the display unit 84 includes two LCDs, and the display control unit 815 may display the detection result of the first detection unit 812 on one LCD and may display the detection result of the second detection unit 813 on the other LCD. The display control unit 815 displays the detection result of the first detection unit 812 and the detection result of the second detection unit 813 in association with each other. For example, the display control unit 815 displays the detection result of the first detection unit 812 and the detection result of the second detection unit 813 in time synchronization with each other. In other words, the display control unit 815 displays the detection result of the first detection unit 812 at a time T and the detection result of the second detection unit 813 at a time T.

The output unit 816 receives an instruction from the user via the input unit 83, and outputs various information to a terminal device 9 communicatably connected to the detection control device 8 based on the instruction from the user. The output unit 816 outputs, to the terminal device 9, for example, the detection result of the strain ε and the testing force F, the detection result of the strain distribution DT, and the strain distribution image PDT, which are stored in the detection result storage unit 821.

The terminal device 9 includes, for example, a personal computer, a tablet terminal, and a smartphone.

In the present embodiment, the output unit 816 outputs various information to the terminal device 9, but the output unit 816 may output various information to a recording medium such as a universal serial bus (USB) memory, an HDD, and an SSD.

4. Method of Detecting Strain Distribution

Next, an example of a method of detecting the vertical strain distribution DT1 of the test piece TP will be described with reference to FIGS. 4 and 5.

FIG. 4 is a diagram illustrating an example of the pattern image PN according to the present embodiment. The pattern image PN1 on the left side of FIG. 4 shows an example of the pattern PTN of the test piece TP in an initial state. The pattern PTN indicates a lattice pattern PTN. That is, in the pattern image PN1, square black-painted images Qij (i=1 to n, j=1 to 8) are arranged at an equal interval in the lateral direction and the vertical direction.

The black-painted image Qij is, for example, a square of which one side is 1 mm long. For example, the black-painted image Qij is arranged at an interval of 1 mm in the lateral direction and the vertical direction.

The pattern image PN2 on the right side of FIG. 4 shows an example of the pattern PTN in a state in which the test piece TP is elongated in the vertical direction. That is, in the pattern image PN2, rectangular black-painted images Rij (i=1 to n, j=1 to 8) are arranged at a substantially equal interval in the lateral direction and the vertical direction.

An x-axis of FIG. 4 will be described with reference to FIG. 5.

FIG. 5 is a diagram illustrating an example of a method of calculating the vertical strain distribution DT1 of the test piece TP.

In FIG. 5, the detection control device 8 calculates, for example, a displacement amount in the x-axis direction. A standard point of the displacement amount is the center of the black-painted image Q14 or the center of the black-painted image R14, the black-painted image Q14 and the black-painted image R14 being located at the lowermost end. That is, by comparing the distance between the black-painted image Ri4 (i=2 to n) and the black-painted image R14 with the distance between the black-painted image Qi4 (i=2 to n) and the black-painted image Q14, the displacement amount in the x-axis direction is calculated.

The x-axis direction indicates a long side direction of the test piece TP.

A graph G11 at the top of FIG. 5 is a graph obtained by a sine wave approximation of a change of a luminance value B in the x-axis direction. A lateral axis of the graph G11 is an x-axis, and a vertical axis is the luminance value B. The luminance value B is low in the black-painted image Ri4, and the luminance value B is high between the black-painted image Ri4 and the adjacent black-painted image R(i+1)4. Therefore, the change in the luminance value B in the x-axis direction is represented by a rectangular graph (not shown).

The graph G11 is a graph obtained by approximating the rectangular graph by a sine wave between the black-painted image Ri4 and the adjacent black-painted image R(i+1)4. When the pattern image PN is the pattern image PN1, the graph Gil becomes a sine wave since the black-painted images Qi4 in the pattern image PN1 are formed at an equal interval.

A second graph G12 from the top of FIG. 5 is a graph showing a phase φ of the graph G11. A lateral axis of the graph G12 is an x-axis, and a vertical axis is a phase φ. The phase φ varies from −π to +π. Therefore, the graph G12 becomes a saw blade-shaped graph. That is, in the graph G12, the phase increases linearly from −π to +π as an x-coordinate increases, and the phase decreases stepwise to −π at a position in which the phase reaches +π.

In the present embodiment, the detection control device 8 calculates, for example, a phase φ(x) shown in the graph G12 by a windowed Fourier transform shown in Equation (2).

[Math. 1]

ϕ(x)=angle(∫s(u)w(u−x)exp(−j2πfu)du) (2)

In the windowed Fourier transform, Fourier transformation is performed after weighting the periphery of target coordinates by using a window function w(x), and the phase φ(x) is obtained by extracting a frequency component of a lattice period. The lattice period corresponds to the distance between the black-painted image Ri4 (i=2 to n) and the black-painted image R14.

When a frequency f is replaced with (1/N), a nonzero range of the window function w(x) is set to (2N−1), and a phase calculation is rewritten by the discrete Fourier transform, Equation (3) is obtained.

$$\begin{matrix}[ Math . 2 ] & \\ ϕ ( x ) = - {tan}^{- 1} \frac{{\sum }_{i = - ( N - 1 )}^{N - 1} w ( i ) s ( x + i ) sin ( 2 π i / N )}{{\sum }_{i = - ( n - 1 )}^{N - 1} w ( i ) s ( x + i ) son ( 2 π i / N )} & ( 3 )\end{matrix}$$

However, the number N indicates the number of pixels corresponding to one cycle. The number N is, for example, ten. An example of a graph WD indicating the window function w is shown at a right end position of the graph G11 at the top of FIG. 5.

In the present embodiment, a Gaussian function shown in Equation (4) is used as the window function w(x).

$$\begin{matrix}[ Math . 3 ] & \\ w ( i ) = exp ( - \frac{{i}^{2}}{2 {σ}^{2}} ) & ( 4 )\end{matrix}$$

However, a coefficient σ is a coefficient that determines an enlargement of a base of a Gaussian window.

Since the phase φ obtained by Equation (3) is folded between −π and +π, that is, wrapped, a correct value may not be obtained when a difference between the phases φ is taken for different coordinates. Therefore, as shown in Equation (5), the phases φ are connected continuously by a phase unwrapping processing.

$$\begin{matrix}[ Math . 4 ] & \\ Φ ( x ) = unwrap ( ϕ ( x ) ) + \frac{2 π}{N} x & ( 5 )\end{matrix}$$

The phase unwrapping processing indicates processing of restoring the phase φ folded in the range of −π to +π.

A graph G13 in the lowermost in FIG. 5 shows a graph after the phase unwrapping processing is performed on the second graph G12 from the top in FIG. 5. A lateral axis of the graph G13 is an x-axis, and a vertical axis is a phase φ. In the graph G12, the phase φ decreases stepwise to −π at the position in which the phase φ reaches +π, but in the graph G13, the phase φ increases by 2xπ every time the phase φ decreases from +π to −π so that the phase φ is not changed stepwise. As a result, the unwrapped phase φ is obtained. As shown in the graph G13, the phase φ increases linearly as the x-coordinate increases.

From a gradient of the unwrapped phase φ, a local lattice period P(x) is obtained by Equation (6).

$$\begin{matrix}[ Math . 5 ] & \\ P ( x ) = \frac{2 π}{\frac{d Φ ( x )}{dx}} & ( 6 )\end{matrix}$$

A graph G14 corresponds to the pattern image PN2. The graph G14 has a slope smaller than that of the graph G13. That is, the difference between the coordinates of the x-axis for changing the phase φ by 2xπ is a distance LA in the graph G13 whereas the difference between the coordinates of the x-axis for changing the phase φ by 2xπ is a distance LB in the graph G14. The distance LB is greater than the distance LA. The difference between the distance LB and the distance LA indicates a displacement ΔL.

In this way, the detection control device 8 can calculate the displacement distribution on the surface of the test piece TP. That is, a Strain (x) indicating a vertical strain is obtained by Equation (7).

$$\begin{matrix}[ Math . 6 ] & \\ Strain ( x ) = \frac{{P}_{a} ( x ) - {P}_{b} ( x )}{{P}_{b} ( x )} & ( 7 )\end{matrix}$$

However, a lattice period Pb(x) indicates a lattice period before deformation, and a lattice period Pa(x) indicates a lattice period after deformation.

5. Test Result Display Screen

FIG. 6 is a screen view illustrating an example of the test result display screen 700 displayed on the display unit 84.

The test result display screen 700 is displayed on the display unit 84 by the display control unit 815 during and after the tensile test.

The test result display screen 700 includes a stress-strain curve display unit 701, a strain distribution display unit 702, a time designation unit 703, and a type selection unit 704.

The stress-strain curve display unit 701 displays a graph showing a stress-strain curve G2. The vertical axis of the graph is testing force F(N), and the lateral axis is a strain ε (%). The testing force F is detected by the load cell 14 illustrated in FIG. 1. The strain ε is detected by the first detection unit 812 illustrated in FIG. 3.

During the tensile test, the stress-strain curve G2 is updated every time the testing force F and the strain ε are detected. That is, the stress-strain curve G2 is updated according to a progress of the tensile test.

On the other hand, after the tensile test, the stress-strain curve G2 showing the test results is displayed.

A designation point PA is displayed when the user designates the testing force F or the strain ε. For example, when the user places a cursor on the designation point PA and clicks a mouse, the designation point PA is displayed.

The strain ε corresponding to the designation point PA is 1.276, and the testing force F corresponding to the designation point PA is 22395.510.

In this way, the reception unit 814 receives the designation of the strain ε or the testing force F corresponding to the designation point PA from the user.

FIG. 6 describes a case in which the stress-strain curve display unit 701, which displays a graph having the testing force F and the strain ε as axes as the detection result of the first detection unit 812, is displayed, but a graph having other parameters used in an elongation measurement as axes may be displayed. For example, as other parameters, when a graph having the time T and the strain ε within the test period of the tensile test as axes is displayed, the corresponding strain ε can be displayed by the user designating the time T.

The strain distribution display unit 702 displays the strain distribution image PDT. The strain distribution image PDT shows the strain distribution DT of the test piece TP detected by the second detection unit 813.

During the tensile test, a strain distribution image PDT is generated, and the generated strain distribution image PDT is displayed on the strain distribution display unit 702 every time the strain distribution DT is detected by the second detection unit 813.

On the other hand, after the tensile test, the strain distribution image PDT corresponding to the time T, strain ε, or the testing force F received by the reception unit 814 is read from the detection result storage unit 821 and displayed on the strain distribution display unit 702. A contour line display and a heat map display are preferable as a display format of the strain distribution image PDT.

The time designation unit 703 is used when the user designates the time T within the test period. The time designation unit 703 displays a period frame 703A indicating the test period, a bar graph 703B indicating the time T, a time display unit TA indicating the time T, and a test period display unit TT indicating the test period.

The test period is “3 minutes 27.75 seconds” as described to be “03:27:75” in test period display unit TT. The test period indicates a period from the start to the end of the test.

As described to be “00:17:59” in the time display unit TA, the time T is “17.59 seconds” after the start of the test. The bar graph 703B shows that the time T is “17.59 seconds” after the start of the test.

For example, when the user places the cursor at the right end position of the bar graph 703B in the period frame 703A and clicks the mouse, the time T is designated to be “17.59 seconds”.

In this way, the reception unit 814 receives the designation of the time T from the user.

When the designation of the time T is received, the designation point PA corresponding to the time T is displayed on the stress-strain curve display unit 701.

The strain distribution image PDT corresponding to the time T is read from the detection result storage unit 821, and displayed on the strain distribution display unit 702.

When the detection result of the first detection unit 812 is represented by, for example, a graph showing a relationship between the time T and the strain ε, the user can designate the time T on the display unit 701 instead of the bar graph 703B.

The type selection unit 704 is used when the designation of the strain distribution DT to be displayed on the strain distribution display unit 702 is received.

For example, when the user places the cursor at the position of the type selection unit 704, and clicks the mouse, a so-called pull-down menu is displayed. In the pull-down menu, one of the vertical strain distribution DT1, the lateral strain distribution DT2, and the shear strain distribution DT3 is displayed so as to be selectable. FIG. 6 illustrates a state in which the vertical strain distribution DT1 is selected.

When the vertical strain distribution DT1 is selected, the strain distribution image PDT showing the vertical strain distribution DT1 is read from the detection result storage unit 821 and displayed on the strain distribution display unit 702. When the lateral strain distribution DT2 is selected, the strain distribution image PDT showing the lateral strain distribution DT2 is read from the detection result storage unit 821 and displayed on the strain distribution display unit 702. When the shear strain distribution DT3 is selected, the strain distribution image PDT showing the shear strain distribution DT3 is read from the detection result storage unit 821 and displayed on the strain distribution display unit 702.

6. Specific Example of Test Result

Next, an example of a change of the strain ε and the image displayed on the strain distribution display unit 702 during the tensile test will be described with reference to FIGS. 7 to 11.

FIGS. 7 to 11 illustrate the test result when a tensile test of carbon fiber reinforced plastics (CFRP) having a circular hole HL in the center of the test piece TP is performed.

Each of FIGS. 7 to 11 illustrates a graph indicating a stress-strain curve G3 displayed on the stress-strain curve display unit 701 and the strain distribution image PDT displayed on the strain distribution display unit 702.

In the strain distribution image PDT illustrated in each of FIGS. 7 to 11, a density of a hatching is set according to the magnitude of the strain ε.

In each of FIGS. 7 to 11, for example, when the strain ε is 0 or more and less than 1.32, the strain distribution image PDT is not hatched. When the strain ε is 1.32 or more and less than 2.64, the strain distribution image PDT is hatched at a first density. When the strain ε is 2.64 or more and less than 3.96, the strain distribution image PDT is hatched at a second density that is higher than the first density. When the strain ε is 3.96 or more and less than 5.28, the strain distribution image PDT is hatched at a third density that is higher than the second density. When the strain ε is 5.28 or more and less than 6.6, the strain distribution image PDT is hatched at a fourth density that is higher than the third density.

In the following description, a region, which is not hatched, is referred to as a first region, a region hatched at the first density is referred to as a second region, and a region hatched at the second density is referred to as a third region. A region hatched at the third density is referred to as a fourth region, and a region hatched at the fourth density is referred to as a fifth region.

FIG. 7 is a diagram illustrating a first example of the strain ε and the strain distribution image PDT.

In the strain distribution image PDT, an image corresponding to each of the first reference point DP1 and the second reference point DP2 is displayed. The distance L1 between the reference points is greater than the distance L0 between the reference points, which indicates the distance L between the reference points before the tensile test is started. The first detection unit 812 detects a strain ε (%) of the test piece TP by using Equation (1) described with reference to FIG. 3.

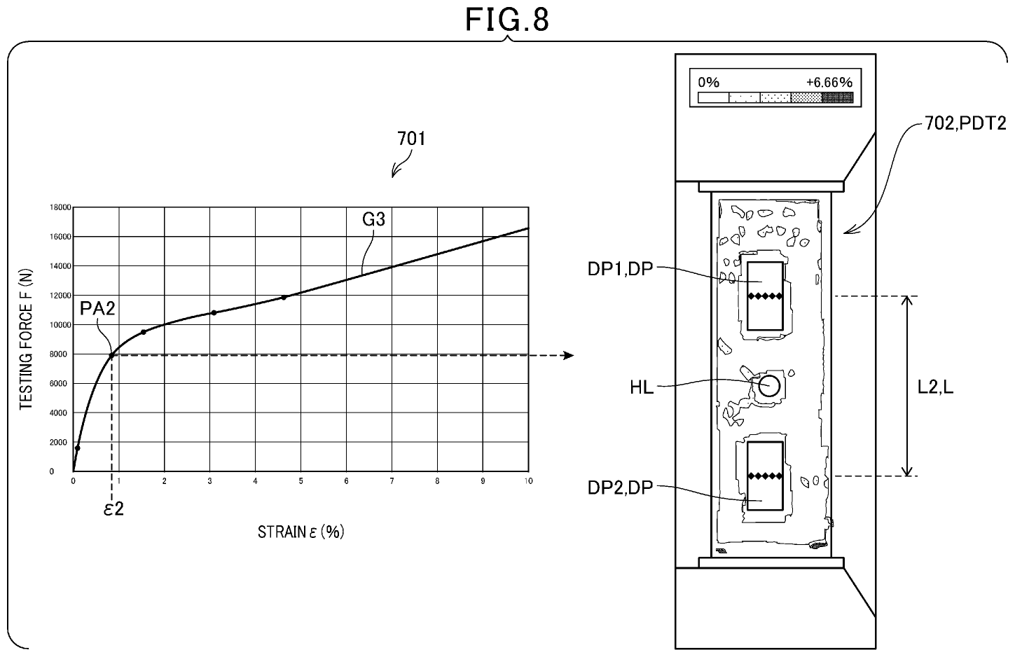

Each of FIGS. 8 to 11 illustrates the distance L2 between the reference points, the distance L3 between the reference points, the distance L4 between the reference points, and the distance L5 between the reference points.

In FIG. 7, the strain ε is a strain ε1. The strain ε1 is, for example, 0.17%.

A strain distribution image PDT1 indicates the strain distribution image PDT when the strain ε is the strain ε1. In the strain distribution image PDT1, the entire region is the first region, that is, the strain ε is less than 1.332 in the entire region of the test piece TP.

FIG. 8 is a diagram illustrating a second example of the strain ε and the strain distribution image PDT.

In FIG. 8, the strain ε is a strain ε2. The strain ε2 is, for example, 0.85%.

A strain distribution image PDT2 indicates the strain distribution image PDT when the strain ε is the strain ε2. In the strain distribution image PDT2, the second regions are scattered in the first region. That is, the strain ε is 1.332 or more and less than 2.664 in a partial region of the test piece TP.

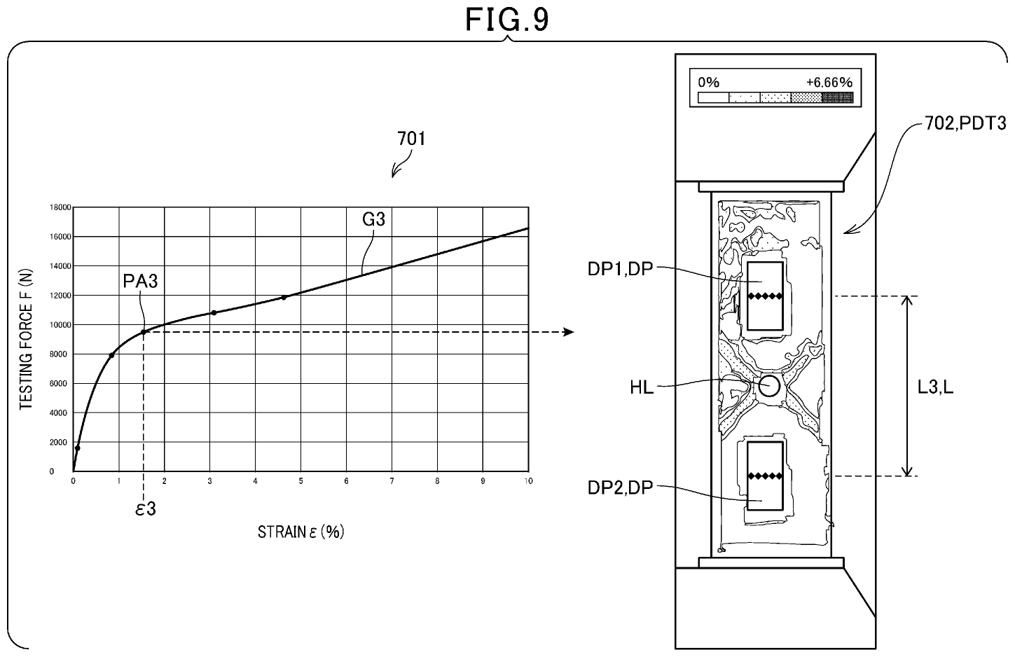

FIG. 9 is a diagram illustrating a third example of the strain ε and the strain distribution image PDT.

In FIG. 9, the strain ε is a strain ε3. The strain ε3 is, for example, 1.65%.

A strain distribution image PDT3 indicates the strain distribution image PDT when the strain ε is the strain ε3. In the strain distribution image PDT3, the second regions and the third regions are scattered in the first region. In particular, there are four radial strip-shaped third regions around the hole HL. Each of the four strip-shaped third regions extends from the outer periphery of the hole HL in an upper right direction, a lower right direction, an upper left direction, and a lower left direction. Among the four third regions, the strip-shaped third regions adjacent to each other form approximately 90 degrees.

The strain ε of the four strip-shaped third regions is 2.664 or more and less than 3.996. That is, a strain ε larger than those of other regions is generated in the four strip-shaped third regions.

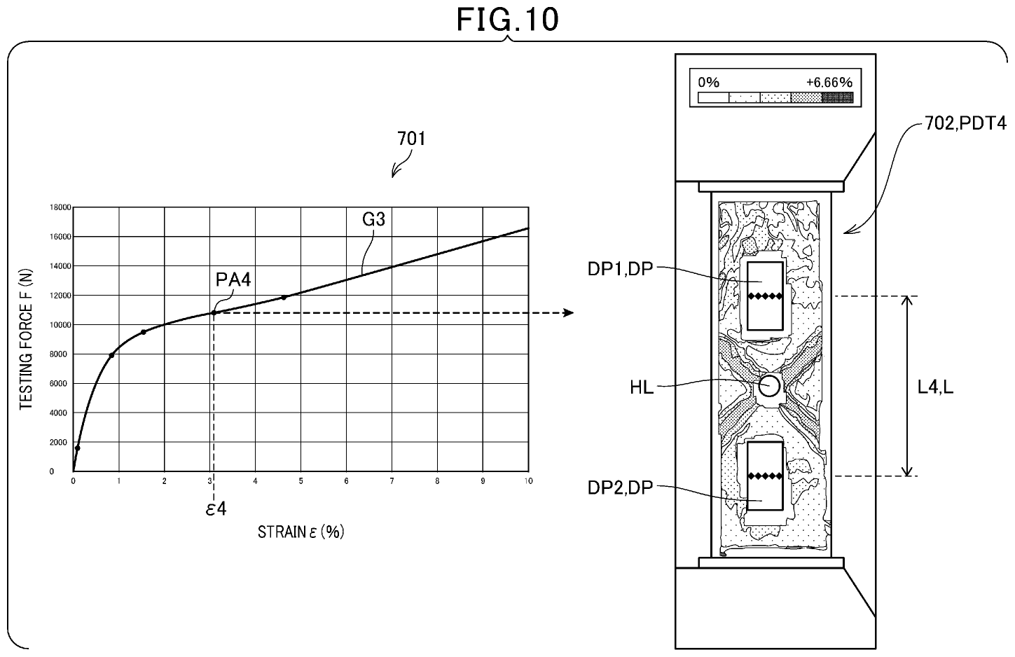

FIG. 10 is a diagram illustrating a fourth example of the strain ε and the strain distribution image PDT.

In FIG. 10, the strain ε is a strain ε4. The strain ε4 is, for example, 3.15%.

A strain distribution image PDT4 indicates the strain distribution image PDT when the strain ε is the strain ε4. In the strain distribution image PDT4, the first regions, the second regions, and the fourth regions are scattered in the third region. In particular, there are four radial strip-shaped fourth regions around the hole HL. Each of the four strip-shaped fourth regions extends from the outer periphery of the hole HL in an upper right direction, a lower right direction, an upper left direction, and a lower left direction. Among the four fourth regions, the strip-shaped fourth regions adjacent to each other form approximately 90 degrees.

The strain ε of the four strip-shaped fourth regions is 3.996 or more and less than 5.328. That is, a strain ε larger than those of other regions is generated in the four strip-shaped fourth regions.

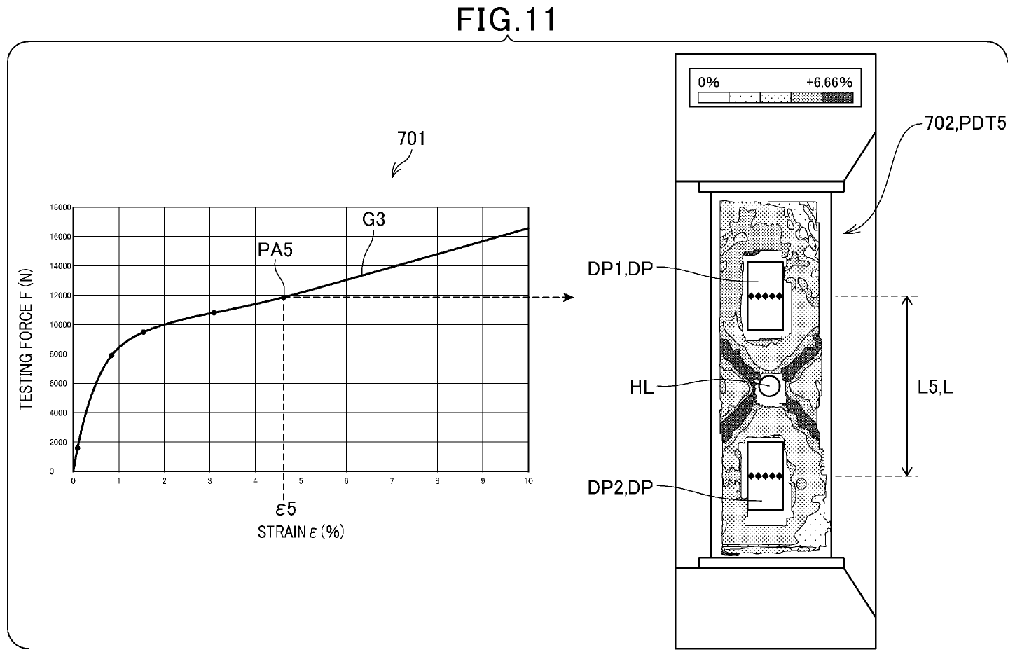

FIG. 11 is a diagram illustrating a fifth example of the strain ε and the strain distribution image PDT.

In FIG. 11, the strain ε is a strain ε5. The strain ε5 is, for example, 4.65%.

A strain distribution image PDTS indicates the strain distribution image PDT when the strain ε is the strain ε5. In the strain distribution image PDTS, the fourth regions and the fifth regions are scattered in the third region. In particular, there are four radial strip-shaped fifth regions around the hole HL. Each of the four strip-shaped fifth regions extends from the outer periphery of the hole HL in an upper right direction, a lower right direction, an upper left direction, and a lower left direction. Among the four fifth regions, the strip-shaped fifth regions adjacent to each other form approximately 90 degrees.

The strain ε of the four strip-shaped fifth regions is 5.328 or more and less than 6.66. That is, a strain ε larger than those of other regions is generated in the four strip-shaped fifth regions.

As described above with reference to FIGS. 7 to 11, it can be seen that when the strain ε is 1.65% or more, four strip-shaped regions having the strain ε larger than those of other regions are generated radially around the hole HL. In this way, by displaying the strain ε and the strain distribution image PDT on one screen and changing the strain ε, for example, knowledge regarding a characteristic change of the strain distribution DT of the test piece TP according to the change of the strain ε can be obtained.

7. Processing of Control Unit

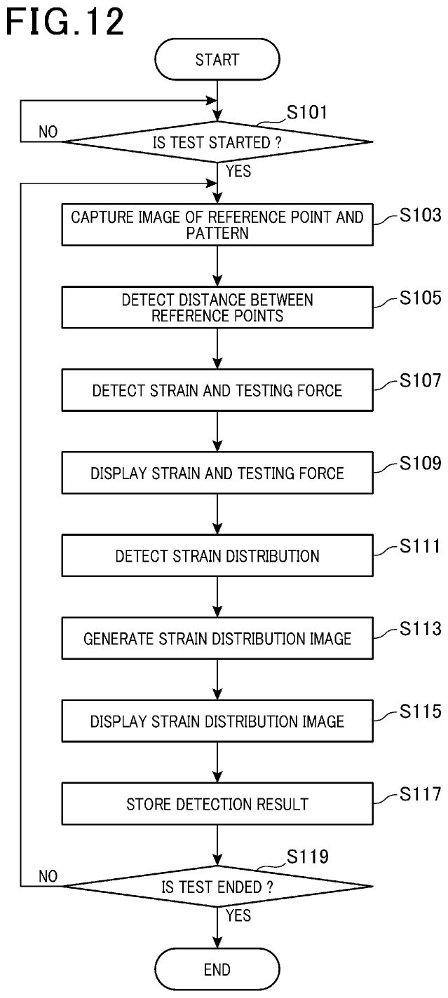

FIGS. 12 to 14 are flowcharts each illustrating an example of processing of the control unit 81.

FIG. 12 is a flowchart illustrating an example of processing of the control unit 81 during the tensile test.

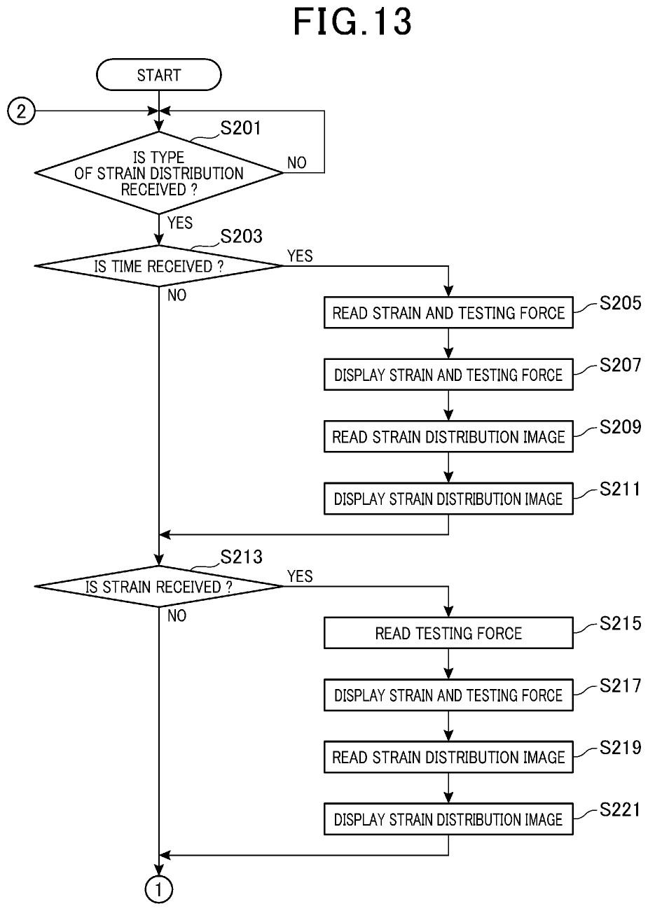

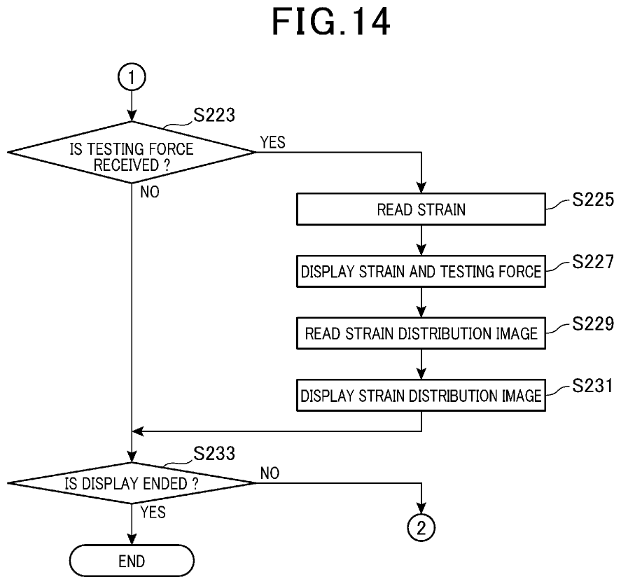

FIGS. 13 and 14 are flowcharts each illustrating an example of processing of the control unit 81 after the tensile test.

The processing of the control unit 81 during the tensile test will be described with reference to FIG. 12.

First, in Step S101, the control unit 81 determines whether or not the tensile testing machine 1 starts the tensile test based on information from the control circuit unit 50.

When the control unit 81 determines that the tensile testing machine 1 does not start the tensile test (NO in Step S101), the processing is in a standby state. When the control unit 81 determines that the tensile testing machine 1 starts the tensile test (YES in Step S101), the processing proceeds to Step S103.

In Step S103, the imaging control unit 811 causes the camera 6 to capture an image including the pattern PTN and the image of the reference point DP, which are formed on the test piece TP, and generates a pattern image PN showing the image of the pattern PTN and an image of the reference point DP.

Next, in Step S105, the first detection unit 812 calculates a distance L between the reference points based on the image of the reference point DP.

Next, in Step S107, the first detection unit 812 detects the strain ε based on the distance L between the reference points, and the control unit 81 detects testing force F.

Next, in Step S109, the display control unit 815 displays, on the display unit 84, the strain ε and the testing force F as a stress-strain curve G2 of the test result display screen 700 illustrated in FIG. 6.

Next, in Step S111, the second detection unit 813 detects the strain distribution DT of the test piece TP based on the image of the pattern PTN formed on the surface of the test piece TP.

Next, in Step S113, the control unit 81 generates a strain distribution image PDT showing a strain distribution DT.

Next, in Step S115, the display control unit 815 displays the strain distribution image PDT on the display unit 84.

Next, in Step S117, the control unit 81 stores, in the detection result storage unit 821, the strain ε, the testing force F, the strain distribution DT, and the strain distribution image PDT in association with the time T. The strain distribution DT includes the vertical strain distribution DT1, the lateral strain distribution DT2, and the shear strain distribution DT3. The strain distribution image PDT includes an image indicating the vertical strain distribution DT1, an image indicating the lateral strain distribution DT2, and an image indicating the shear strain distribution DT3.

Next, in Step S119, the control unit 81 determines whether or not the tensile testing machine 1 ends the tensile test based on information from the control circuit unit 50.

When the control unit 81 determines that the tensile testing machine 1 does not end the tensile test (NO in Step S119), the processing returns to Step S103. When the control unit 81 determines that the tensile testing machine 1 ends the tensile test (YES in Step S119), the processing is ended.

Step S107 corresponds to an example of a “first detection step”. Step S111 corresponds to an example of a “second detection step”. Steps S109 and S115 correspond to an example of a “display step”.

The processing of the control unit 81 after the tensile test will be described with reference to FIGS. 13 and 14.

In addition, in FIGS. 13 and 14, a case in which the control unit 81 displays the test result display screen 700 illustrated in FIG. 6 on the display unit 84, and displays a still image of the strain distribution DT on the strain distribution display unit 702 is described.

First, as illustrated in FIG. 13, in Step S201, the reception unit 814 determines whether or not one strain distribution DT among the vertical strain distribution DT1, the lateral strain distribution DT2, and the shear strain distribution DT3 is received.

When the reception unit 814 determines that one strain distribution DT is not received (NO in Step S201), the processing is in a standby state. When the reception unit 814 determines that one strain distribution DT is received (YES in Step S201), the processing proceeds to Step S203.

In Step S203, the reception unit 814 determines whether or not the designation of the time T within the test period for the test piece TP is received.

When the reception unit 814 determines that the designation of the time T is not received (NO in Step S203), the processing proceeds to Step S213. When the reception unit 814 determines that the designation of the time T is received (YES in Step S203), the processing proceeds to Step S205.

In Step S205, the display control unit 815 reads the strain ε and the testing force F, which correspond to the time T, from the detection result storage unit 821.

Next, in Step S207, the display control unit 815 displays the designation point PA corresponding to the strain ε and the testing force F on the stress-strain curve display unit 701.

Next, in Step S209, the display control unit 815 reads the strain distribution image PDT corresponding to the time T from the detection result storage unit 821. The strain distribution image PDT corresponds to one strain distribution DT received in Step S201.

Next, in Step S211, the display control unit 815 displays the strain distribution image PDT on the strain distribution display unit 702. After that, the processing proceeds to Step S213.

Next, in Step S213, the reception unit 814 determines whether or not the designation of the strain ε of the test piece TP is received.

When the reception unit 814 determines that the designation of the strain ε of the test piece TP is not received (NO in Step S213), the processing proceeds to Step S223 illustrated in FIG. 14. When the reception unit 814 determines that the designation of the strain ε of the test piece TP is received (YES in Step S213), the processing proceeds to Step S215.

In Step S215, the display control unit 815 reads the testing force F corresponding to the strain ε from the detection result storage unit 821.

Next, in Step S217, the display control unit 815 displays the designation point PA corresponding to the strain ε and the testing force F on the stress-strain curve display unit 701.

Next, in Step S219, the display control unit 815 reads the strain distribution image PDT corresponding to the strain ε from the detection result storage unit 821. Specifically, the display control unit 815 reads the time T corresponding to the strain ε from the detection result storage unit 821, and reads the strain distribution image PDT corresponding to the time T from the detection result storage unit 821. The strain distribution image PDT corresponds to one strain distribution DT received in Step S201.

Next, in Step S221, the display control unit 815 displays the strain distribution image PDT on strain distribution display unit 702. After that, the processing proceeds to Step S223 of FIG. 14.

Next, as illustrated in FIG. 14, in Step S223, the reception unit 814 determines whether or not the designation of the testing force F is received.

When the reception unit 814 determines that the designation of the testing force F is not received (NO in Step S223), the processing proceeds to Step S233. When the reception unit 814 determines that the designation of the testing force F is received (YES in Step S223), the processing proceeds to Step S225.

In Step S225, the display control unit 815 reads the strain ε corresponding to the testing force F from the detection result storage unit 821.

Next, in Step S227, the display control unit 815 displays the designation point PA corresponding to the strain ε and the testing force F on the stress-strain curve display unit 701.

Next, in Step S229, the display control unit 815 reads the strain distribution image PDT corresponding to the testing force F from the detection result storage unit 821. Specifically, the display control unit 815 reads the time T corresponding to the testing force F from the detection result storage unit 821, and reads the strain distribution image PDT corresponding to the time T from the detection result storage unit 821. The strain distribution image PDT corresponds to one strain distribution DT received in Step S201.

Next, in Step S231, the display control unit 815 displays the strain distribution image PDT on the strain distribution display unit 702. After that, the processing proceeds to Step S233.

Then, in Step S233, the control unit 81 determines whether or not to end the display of the test result display screen 700 on the display unit 84 based on the instruction from the user.

When the control unit 81 determines not to end the display of the test result display screen 700 on the display unit 84 (NO in Step S233), the processing returns to Step S201 of FIG. 13. When the control unit 81 determines to end the display of the test result display screen 700 on the display unit 84 (YES in Step S233), the processing is ended.

As described with reference to FIGS. 13 and 14, by designating the parameter included in the test result, the detection result obtained by the first detection unit 812 and corresponding to the designated parameter, and the detection result obtained by the second detection unit 813 and corresponding to the designated parameter are displayed on one screen. Therefore, the user can confirm the result obtained by measuring the distance between the reference points, which is a quantitative measurement result, and the result of the strain distribution measurement, which is a qualitative measurement result for each position information of the test piece TP, in association with each other.

8. Aspects and Effects

It will be understood by those skilled in the art that the above-described embodiments and modification examples are specific examples of the following aspects.

Item 1

Provided is a material testing machine according to an aspect, which deforms a test piece and measures mechanical properties of a material of the test piece, the material testing machine including: a first detection unit that detects at least one of elongation and a strain of the test piece by measuring a distance between reference points of the test piece; a second detection unit that detects a strain distribution of the test piece based on an image of a pattern formed on a surface of the test piece; and a display unit that displays a detection result of the first detection unit and a detection result of the second detection unit in association with each other.

In the material testing machine described in Item 1, a detection result of at least one of the elongation and the strain of the test piece and a detection result of the strain distribution of the test piece are displayed in association with each other.

Therefore, information desired by a user can be provided.

Item 2

In the material testing machine described in Item 1, the display unit displays each of the detection result of the first detection unit and the detection result of the second detection unit in association with an elapsed time from start of a test.

In the material testing machine described in Item 2, each of the detection result of the first detection unit and the detection result of the second detection unit is displayed in association with the elapsed time from the start of the test.

Therefore, information desired by a user can be provided.

Item 3

The material testing machine described in Item 1 or Item 2, further includes a storage unit that stores each of the detection result of the first detection unit and the detection result of the second detection unit in association with an elapsed time from start of a test.

In the material testing machine described in Item 3, the storage unit stores each of the detection result of the first detection unit and the detection result of the second detection unit in association with the elapsed time from the start of the test.

Therefore, the display unit can easily display each of the detection result of the first detection unit and the detection result of the second detection unit in association with each other.

Item 4

In the material testing machine described in any one of Item 1 to Item 3, the display unit displays the detection result of the first detection unit and the detection result of the second detection unit on one screen.

In the material testing machine described in Item 4, the display unit displays the detection result of the first detection unit and the detection result of the second detection unit on one screen.

Therefore, information desired by a user can be provided.

Item 5

The material testing machine described in any one of Item 1 to Item 4, further includes a first reception unit that receives a designation of a time within a test period for the test piece, in which the display unit displays the detection result of the first detection unit, which corresponds to the time received by the first reception unit, and the detection result of the second detection unit, which corresponds to the time received by the first reception unit, in association with each other.

In the material testing machine described in Item 5, a detection result of at least one of the elongation and the strain of the test piece and a detection result of the strain distribution of the test piece, which correspond to the received time, are displayed in association with each other.

Therefore, information desired by a user can be provided.

Item 6

The material testing machine described in any one of Item 1 to Item 5, further includes a second reception unit that receives a designation of the elongation or the strain of the test piece, which is detected by the first detection unit, in which the display unit displays the detection result of the second detection unit, which corresponds to the elongation or the strain received by the second reception unit.

In the material testing machine described in Item 6, the detection result of a strain distribution of the test piece, which corresponds to the received elongation or strain, is displayed.

Therefore, information desired by a user can be provided.

Item 7

The material testing machine according to any one of Item 1 to Item 6, further includes a third detection unit that detects testing force applied to the test piece, and a third reception unit that receives a designation of the testing force detected by the third detection unit, in which the display unit displays the detection result of the first detection unit, which corresponds to the testing force received by the third reception unit, and the detection result of the second detection unit, which corresponds to the testing force received by the third reception unit, in association with each other.

In the material testing machine described in Item 7, the detection result of at least one of the elongation and the strain of the test piece and the detection result of the strain distribution of the test piece, which correspond to the received testing force, are displayed in association with each other.

Therefore, information desired by a user can be provided.

Item 8

In the material testing machine described in any one of Item 1 to Item 7, the detection result of the first detection unit is represented by a graph having two of the strain of the test piece, the elongation of the test piece, testing force applied to the test piece, and an elapsed time from start of a test as a vertical axis and a lateral axis.

In the material testing machine described in Item 8, the display unit displays, as the detection result of the first detection unit, a graph having two of the strain of the test piece, the elongation of the test piece, the testing force applied to the test piece, and the elapsed time from the start of the test as a vertical axis and a lateral axis.

For example, as shown in the stress-strain curve display unit 701 of the test result display screen 700 of FIG. 6, the stress-strain curve G2 in which the vertical axis indicates the testing force F(N) and the lateral axis indicates the strain ε (%) can be displayed. Therefore, information desired by a user can be provided.

Item 9

In the material testing machine described in any one of Item 1 to Item 8, the detection result of the second detection unit is represented by a contour line graph of a strain distribution of the test piece.

In the material testing machine described in Item 9, the display unit displays, as the detection result of the second detection unit, the contour line graph of the strain distribution of the test piece.

For example, as shown in the strain distribution image PDT of FIGS. 7 to 11, the contour line graph of the strain distribution of the test piece TP can be displayed. Therefore, information desired by a user can be provided.

Item 10

In the material testing machine described in any one of Item 1 to Item 9, the strain distribution of the test piece includes a vertical strain distribution, a lateral strain distribution, and a shear strain distribution, and the display unit displays, as the detection result of the second detection unit, at least one of the vertical strain distribution, the lateral strain distribution, and the shear strain distribution.

In the material testing machine described in Item 10, at least one of the vertical strain distribution, the lateral strain distribution, and the shear strain distribution is displayed as the detection result of the second detection unit.

Therefore, information desired by a user can be provided.

Item 11

The material testing machine described in Item 10, further includes a fourth reception unit that receives one strain distribution among the vertical strain distribution, the lateral strain distribution, and the shear strain distribution, in which the display unit displays one strain distribution received by the fourth reception unit as the detection result of the second detection unit.

In the material testing machine described in Item 11, one strain distribution received among the vertical strain distribution, the lateral strain distribution, and the shear strain distribution is displayed.

Therefore, information desired by a user can be provided.

Item 12

In the material testing machine described in any one of Item 1 to Item 11, the material testing machine is communicatably connected to a terminal device, and further includes an output unit that outputs, to the terminal device, information indicating the detection result of the first detection unit and information indicating the detection result of the second detection unit in association with information indicating a time within a test period for the test piece.

In the material testing machine described in Item 12, the information indicating the detection result of the first detection unit and the information indicating the detection result of the second detection unit are output to the terminal device in association with the information indicating the time within the test period for the test piece.

Therefore, information desired by a user can be output to the terminal device.

Item 13

Provided is a display method in a material testing machine according to another aspect, the material testing machine deforming a test piece and measuring mechanical properties of a material of the test piece, the method including: a first detection step of detecting at least one of elongation and a strain of the test piece by measuring a distance between reference points of the test piece; a second detection step of detecting a strain distribution of the test piece based on an image of a pattern formed on a surface of the test piece; and a display step of displaying a detection result in the first detection step and a detection result in the second detection step in association with each other.

In the display method in a material testing machine described in Item 13, the same effect as that of the material testing machine described in Item 1 is obtained.

9. Another Embodiment

The detection device 200 according to the present embodiment is merely an example of an aspect of the material testing machine according to the present invention, and can be arbitrarily modified and applied without departing from the gist of the present invention.

For example, in the present embodiment, a case in which the material testing machine is the tensile testing machine 1 is described, but the present invention is not limited to this. The material testing machine may apply the testing force to the test piece TP, and deform the test piece TP to perform the material test. For example, the material testing machine may be a compression tester, a bending tester, or a torsion tester. For example, the material testing machine may be a fatigue testing machine, or an environmental testing machine.

In the present embodiment, a case in which the circular hole HL is formed on the test piece TP is described, but the present invention is not limited to this. A hole may not be formed on the test piece TP, and a hole having a different shape may be formed on the test piece TP.

In the present embodiment, the pattern PTN is formed in a lattice pattern, but the present invention is not limited to this. For example, the pattern PTN may be formed in a zigzag.

In the present embodiment, the square black-painted image Qij is arranged on the pattern PTN, but the present invention is not limited to this. For example, a circular or diamond-shaped image may be arranged on the pattern PTN.

In the present embodiment, the black-painted image Qij is arranged on the pattern PTN, but the present invention is not limited to this. For example, a blue image, a red image, or a green image may be arranged on the pattern PTN.

In the present embodiment, a case in which the detection control device 8 functions as the imaging control unit 811, the first detection unit 812, the second detection unit 813, the reception unit 814, the display control unit 815, the output unit 816, and the detection result storage unit 821 is described, but the present invention is not limited to this. The control circuit unit 50 may function as at least one of the imaging control unit 811, the first detection unit 812, the second detection unit 813, the reception unit 814, the display control unit 815, the output unit 816, and the detection result storage unit 821. For example, the control circuit unit 50 may function as the imaging control unit 811, the first detection unit 812, the second detection unit 813, the reception unit 814, the display control unit 815, the output unit 816, and the detection result storage unit 821.

Each functional unit illustrated in FIG. 3 indicates a functional configuration, and a specific mounting form is not particularly limited. That is, hardware corresponding to each functional unit is not necessarily needed to be mounted, and functions of a plurality of the functional units can also be implemented by one processor executing a program. In the above-described embodiment, a part of the functions implemented by software may be implemented by hardware, or a part of the functions implemented by the hardware may be implemented by the software.

The processing units of the flowcharts illustrated in FIGS. 12 to 14 are divided depending on a main processing content for easy understanding of the processing of the detection control device 8. Dividing the processing units is not limited by a dividing method and names of the processing units shown in the flowcharts of FIGS. 12 to 14, and the processing units can be divided into more processing units depending on the processing content, and one processing unit also can be divided to include more processing units. The processing order of the above-described flowcharts is not limited to the illustrated example.

The display method in the tensile testing machine 1 can be implemented by causing the processor 81A included in the detection control device 8 to execute a control program corresponding to the display method in the tensile testing machine 1. The control program can also be recorded on the recording medium that can be read by the computer. As the recording medium, a magnetic or optical recording medium or a semiconductor memory device can be used. Specifically, a portable recording medium such as a flexible disk, an HDD, a compact disk read only memory (CD-ROM), a DVD, a Blu-ray (registered trademark) disc, a magneto-optical disk, a flash memory, and a card-type recording medium, or a fixed recording medium is exemplified. The recording medium may be a non-volatile storage device such as a RAM, a ROM, and an HDD, which is an internal storage device included in an image processing device. The control program corresponding to the display method in the tensile testing machine 1 is stored in a server device, and the control program is downloaded from the server device to the detection control device 8, thereby implementing the display method in the tensile testing machine 1.

What is claimed is:

1. A material testing machine that deforms a test piece and measures mechanical properties of a material of the test piece, the material testing machine comprising:
a first detection unit that detects at least one of elongation and a strain of the test piece by measuring a distance between reference points of the test piece;
a second detection unit that detects a strain distribution of the test piece based on an image of a pattern formed on a surface of the test piece; and
a display unit that displays a detection result of the first detection unit and a detection result of the second detection unit in association with each other.

2. The material testing machine according to claim 1, wherein the display unit displays each of the detection result of the first detection unit and the detection result of the second detection unit in association with an elapsed time from start of a test.

3. The material testing machine according to claim 1, further comprising a storage unit that stores each of the detection result of the first detection unit and the detection result of the second detection unit in association with an elapsed time from start of a test.

4. The material testing machine according to claim 1, wherein the display unit displays the detection result of the first detection unit and the detection result of the second detection unit on one screen.

5. The material testing machine according to claim 1, further comprising
a first reception unit that receives a designation of a time within a test period for the test piece,
wherein the display unit displays the detection result of the first detection unit, which corresponds to the time received by the first reception unit, and the detection result of the second detection unit, which corresponds to the time received by the first reception unit, in association with each other.

6. The material testing machine according to claim 1, further comprising
a second reception unit that receives a designation of the elongation or the strain of the test piece, which is detected by the first detection unit,
wherein the display unit displays the detection result of the second detection unit, which corresponds to the elongation or the strain received by the second reception unit.

7. The material testing machine according to claim 1, further comprising:
a third detection unit that detects testing force applied to the test piece; and
a third reception unit that receives a designation of the testing force detected by the third detection unit,
wherein the display unit displays the detection result of the first detection unit, which corresponds to the testing force received by the third reception unit, and the detection result of the second detection unit, which corresponds to the testing force received by the third reception unit, in association with each other.

8. The material testing machine according to claim 1, wherein the detection result of the first detection unit is represented by a graph having two of the strain of the test piece, the elongation of the test piece, testing force applied to the test piece, and an elapsed time from start of a test as a vertical axis and a lateral axis.

9. The material testing machine according to claim 1, wherein the detection result of the second detection unit is represented by a contour line graph of a strain distribution of the test piece.

10. The material testing machine according to claim 1,
wherein a strain distribution of the test piece includes a vertical strain distribution, a lateral strain distribution, and a shear strain distribution, and
the display unit displays, as the detection result of the second detection unit, at least one of the vertical strain distribution, the lateral strain distribution, and the shear strain distribution.

11. The material testing machine according to claim 10, further comprising
a fourth reception unit that receives one strain distribution among the vertical strain distribution, the lateral strain distribution, and the shear strain distribution,
wherein the display unit displays one strain distribution received by the fourth reception unit as the detection result of the second detection unit.

12. The material testing machine according to claim 1,
wherein the material testing machine is communicatably connected to a terminal device, and
further comprises an output unit that outputs, to the terminal device, information indicating the detection result of the first detection unit and information indicating the detection result of the second detection unit in association with information indicating a time within a test period for the test piece.

13. A display method in a material testing machine that deforms a test piece and measures mechanical properties of a material of the test piece, the display method in a material testing machine comprising:
a first detection step of detecting at least one of elongation and a strain of the test piece by measuring a distance between reference points of the test piece;
a second detection step of detecting a strain distribution of the test piece based on an image of a pattern formed on a surface of the test piece; and
a display step of displaying a detection result in the first detection step and a detection result in the second detection step in association with each other.
